(19) United States
(12) Patent Application Publication
(10) Pub. No.: US 2006/0059030 A1
(43) Pub. Date: Mar. 16, 2006

(54) Method and decision support system for optimal allocation of expendable resources in internet marketing with resource-dependant effectiveness and use of a-posteriori information

(76) Inventor: Boris Stavrovski, New York, NY (US)

Correspondence Address: HOFFMANN & BARON, LLP, 6900 JERICHO TURNPIKE, SYOSSET, NY, 11791, US

(21) Appl. No.: 10/942,111

(22) Filed: Sep. 15, 2004

(51) Int. Cl. G06F 9/46

(52) U.S. Cl. 705/8

(57) ABSTRACT

A method and decision support system for optimal allocation of expendable resources in any type of repetitive business transaction with resource-dependant effectiveness and use of a-posteriori information i.e., internet marketing (IM) transaction, in which the computerized system: creates the list of IM providers to be considered, contacts them over the Internet, and collects from them the a-priori data about elementary marketing operations (EMO) available and resource-dependant effectiveness of these EMO; chooses the optimal resource allocation decision making rules (DMR) for EMO to be implemented; implements the EMO, evaluates its results through direct or indirect Internet contact with marketing addressees who responded for the EMO thus collecting a-posteriori data on EMO effectiveness; and checks the current status of resources available and proceeds according to recommendations of optimal DMR chosen previously to the next EMO if resources are available, or ends the current IM operation otherwise.

### BACKGROUND OF THE INVENTION

1. Field of the Invention

This invention relates to a method and a computerized system for implementing any type of repetitive business transaction, whereby on the basis of previous experience with similar transactions (a-posteriori information) some expendable resources should be allocated for each particular transaction thus affecting its effectiveness. In particular, it relates to a method and decision support system for optimal allocation of expendable resources in internet marketing with resource-dependant effectiveness and use of a-posteriori information.

2. Description of the Related Art

There is a common understanding among marketing practitioners that the right resource allocation in marketing constitutes one of the most complicated problems involved in making it effective and efficient at the same time. Recent work has established that marketing investments in advertising, promotions and product improvement can have a long-term impact on sales, and therefore cash flows and profits. On the other hand, such marketing investments are costly and may have a negative impact on short-term profit streams.

There are obviously two very different time horizon planes of the problem. The first one (long-term) has been paid sufficient attention as far as its connection with strategic approach to business marketing management. The second one (short-term or tactical) is also well understood in sense, but has not been supplied with necessary methodical tools in connection with practical cases where very short new data arrays (a-posteriori data) are becoming available after the marketing campaign has already started.

This short-term aspect becomes especially critical for Internet Marketing (IM). A process of IM may be described as a consequence of advertising acts (actions)—creation of pop-up banners, personal e-mails, on-line lottery draws etc. With the goal to implement every such act (without clear beforehand knowledge whether it will be successful or not) the operational party is in need to define the particular type and particular characteristics of the act and to spend some limited resources (money, time, computer resources etc).

A problem of optimal decision making in a majority of the cases used to be formulated formally as a process of definition (generation) of a-priori decision making rules (DMR), i.e. a vector-function D that describes optimal strategies of the operational party only on the basis of usage of certain volume of a-priori known information A (here vector A is the vector of the parameters to be estimated a-priori):
D=f(A).

The process of IM altogether with its dynamics in space and time may be characterized by its informational dynamics as well. The latter demonstrates itself in perpetual accumulation of the information about every successful (and how successful if so) or failed advertisement acts with specific requisites chosen for each act in particular.

Examples of similar accumulation of the information are especially typical for websites, where customers need to login, thus providing a possibility of collecting the statistics about time spent there, personal data and preferences, browsing habits, return visits, referrals, business transactions made etc.

Usage of the new information, which comes that way (and will be named further a-posteriori information), may result in essential corrections of DMR (1) and therefore in some growth of effectiveness for the process of IM.

TABLE 1
Examples of a-priori and a-posteriori estimated parameters.

| | | Types of | | |
|---|---|---|---|---|
| | | Estimations | | |
| Type | Examples | A- | A- | |
| of Parameters | of Parameters | priori | posteriori | Both |
| Type of | Pop-up banner | * | | |
| Marketing | Personal e-mail | | | |
| Operation | Online lottery draw etc | | | |
| Result of an | Sale | | * | |
| Operation | Return Customer | | | |
| | Referral | | | |
| Quantitative | Number of Operations in a | | | * |
| Characteristic | Series | | | |
| of an Operation | Length of a Series | | | |
| Budget | Expenses for each operation | | | * |
| Characteristics | | | | |

The IM operation is usually planned as a sequence of unknown in advance number of elementary advertisement acts, the number of which is unknown in advance. The operational party is spending some expendable resources for each of those acts. We are going to name each step of spending resources—an elementary marketing operation (EMO).

An a-posteriori information that comes after IM operation has begun (for example, expected numbers of EMO, which may differ from the a-priori evaluation for these numbers) may cause a reallocation of available expendable resources, and that means a change in structure of the DMR needs to be implemented. Therefore, we have a necessity for a-posteriori DMR.

Preliminary a-priori information about expected numbers of EMO and their time frame and resource allocation may be available to the operational party before an operation starts. Nevertheless, this information is neither complete nor reliable. Most probably, only the estimates for upper and lower limits of expected EMO numbers are present at that time. Reasonable presumptions about the distribution law for that random variable in-between those limits could be done as well.

On the basis of such unreliable statistical information, the operational party is making decisions about quantities and time frames of resource allocation in a forthcoming operation. Afterwards (when an operation has already started) as long as new a-posteriori information has arrived about EMO that just have been or are planned to be implemented, the process of updating the a-priori information is taking place and decisions about rational allocation of available expendable resources are consecutively done on that basis.

There are several prior art approaches with attempts to help participants in eliminating or at least diminishing some of the problems connected with informational dynamics in resource allocation.

For instance, U.S. Pat. No. 5,838,968 is dedicated to a system and method for dynamic resource management across tasks in real-time operating systems. The system and method manage an arbitrary set of system resources and globally optimize resource allocation across system tasks in a dynamic fashion, according to a system specified performance model. The invention supports a mechanism for defining and managing arbitrary resources through a task resource utilization vector. Each task resource utilization vector contains an arbitrary number of task resource utilization records that contain quantities of system resources that each task qualitatively prefers to utilize while executing on the processor. Each of the task utilization records contains a run level that reflects the associated task's ability to perform its work when allocating the resources according to the particular task resource utilization record. This run level is used to dynamically vary the quantity of system resources that the task has allocated, based on the availability of system resources and the priorities of the tasks.

However, the problem of the step-by step choice in resource allocation on the basis of new a-posteriori data delivery remains unsolved in that patent.

The method and apparatus described in U.S. Pat. No. 6,151,584 relate to a computer architecture and method for validating and collecting dynamic metadata and data about the Internet and electronic commerce environments. The method includes the steps of collecting the customer specific data, and parsing the customer specific data into environmental data and business data. The method also includes the steps of determining information source requirements (representing predetermined requirements) and optional decision support requirements (representing customer specified requirements) responsive to one or both of the environmental data and the business data, and determining core business rules and core data sources responsive to the information source requirements.

A computer architecture and method for collecting, analyzing and/or transforming Internet and/or electronic commerce data for storage into a data storage area described in U.S. Pat. No. 6,151,601, also relates to a computer system that collects, analyzes and/or transforms Internet and/or electronic commerce data of service providers. The Internet and/or electronic commerce data includes one or more of business operational data and network operational data. The mapping system includes a database storing the Internet and/or electronic commerce data for interrogation by the CSP, and at least one computer station including data transformation and database load utilities. The computer station performs one or more of the following functions: transforming and organizing the business operational data; analyzing and organizing the web server operational data pertaining to web page requests, accesses, and browsing into the format suitable to be loaded into the database; analyzing and organizing the Internet operational data pertaining to network sessions and accesses; correlating the network sessions, and authorization and application access data to customers; creating directories of applications; translating raw system data pertaining to Internet and/or electronic commerce applications into a business context; and correlating the business operational data and the network operational data into one or more datasets.

The process of a-posteriori data retrieval is covered in detail by these two last patents, but there is no disclosure of how to use this data in decision making.

There are several patents dealing with IM processes directly.

In U.S. Pat. No. 6,285,983, real-time marketing systems and methods are provided for creating marketing profiles and for directing customized offers to consumers. The systems and methods permit marketers to communicate offers directly to consumers without marketer knowledge of consumer identity. The systems and methods abstract from consumer profile records and securely index the class records created thereby to individual consumers. Without knowledge of consumer identity, marketers can frame real-time offers according to a marketing profile describing elements of the class records and then direct those offers to individual consumers.

U.S. Pat. No. 6,282,567 describes a method for performing enhanced marketing operations upon the Internet that enables a company web server to employ a client web server in its marketing efforts. An application program is installed on a client web server coupled to the Internet. An application program add-on is also installed on the client web server and becomes primarily responsible for the ongoing marketing efforts provided. During the installation process (and thereafter), client information is collected by the application program and/or the application program add-on at the client web server. The application software/application software add-on then relays this client information to the company web server across the Internet for further use. Marketing content is then downloaded from the company web server to the client web server across the Internet. After its receipt, the marketing content is supported upon the client web server to support the marketing efforts of the company.

Finally, U.S. Pat. No. 6,006,197 describes a system and method for assessing effectiveness of an internet marketing campaign—a very important part of any IM resource allocation. Here, a Web advertising measurement system correlates the number of impressions of Web advertisements with post-impression transactional activity to measure the effectiveness of the advertisements. When a user clicks on a banner advertisement, an impression is established and the user's identification is recorded. Then, when the user undertakes post-impression transactional activity, such as downloading software related to the advertisement, ordering products and services related to the advertisement, and so on, the transactional activity along with the user's identification is recorded. Based on the user identifications, the numbers of impressions associated with the advertisements are correlated to the post-impression transactional activity as a measure of effectiveness of each advertisement.

While facilitating IM transactions, these and other prior art methods and systems suffer from many disadvantages and drawbacks.

In particular, none of the prior art approaches is making a very important distinction between structures of DMR (that should be defined before certain IM transaction has started) and concrete values of optimized resource parameters (that are to be chosen for each EMO differently).

Further, none of the prior art documents, related to the IM transaction in question, deals with the whole integrated process—as it in fact is. Recurrent repetitions of the corrected subsequent steps, as a result of a-posteriori data about previous steps are one of the most characteristic and complex features of the process as a whole.

### BRIEF SUMMARY OF THE INVENTION

It is an object of this invention to overcome the aforementioned limitations of the prior art. It is another object of the invention to provide ready access over the Internet for implementing any type of repetitive business transaction, whereby on the basis of previous experience with similar transactions (a-posteriori information) some expendable resources may be allocated for each particular transaction, thus affecting its effectiveness.

In particular, it is an object of the invention to provide a method and a system for optimal allocation of expendable resources in IM with resource-dependant effectiveness and use of a-posteriori information wherein, the system:
creates the list of IM providers to be considered, contacts them over the Internet, and collects from them the a-priori data about EMO available and resource-dependant effectiveness of these EMO;
chooses the optimal resource allocation DMR for EMO to be implemented and calculates optimal resource-dependant effectiveness parameters for the first EMO;
implements the first EMO, evaluates its results through direct or indirect (using IM provider as intermediary) Internet contact with marketing addressees who responded for the first EMO thus collecting a-posteriori data on EMO effectiveness;
checks the current status of resources available and proceeds according to recommendations of optimal DR chosen previously to the next EMO if resources are available, or ends the current IM operation otherwise;
calculates optimal resource-dependant effectiveness parameters for the next EMO, implements the next EMO, and evaluates its results through direct or indirect (using IM provider as intermediary) Internet contact with marketing addressees who responded for that EMO thus collecting a-posteriori data on EMO effectiveness;
recurrently returns to two previous steps of the procedure.

According to one aspect of the invention, the system chooses the optimal resource allocation decision rule D*(A) for EMO to be implemented by evaluating the influence of a-posteriori parameters B in average in accordance with the formula:

$$W [ {D}^{*} ( A ) ] = {max}_{Dε \hat{D}} {\int }_{Bε \hat{B}} W [ D ( A , B ) ] ⅆ F ( B ) ,$$

where
vector-function D (A, B) describes possible strategies of the operational party on the basis of usage of both a-priori (A) and a-posteriori (B) known information;
W [D (A, B)]—some optimality criterion W, to attain the maximal value W* of which constitutes the goal of the operational party in the marketing operation;
\hat{D}—the functional space of the admissible DR D;
an a-priori law of distribution F (B) for a-posteriori evaluated parameters B presumed known; and
\hat{B}—the set of possible values for a-posteriori evaluated parameters B.

According to another aspect of the invention, the system chooses the optimal resource allocation decision rule D*(A) for EMO to be implemented by evaluating the influence of a-posteriori parameters B in a form of considering a most probable value of B, or the value \tilde{B}, which is equal to a mode of the distribution F (B) in accordance with the formula:

$$W [ {D}^{*} ( A ) ] = {max}_{Dε \hat{D}} W [ D ( A , \tilde{B} ) ] ,$$

According to still another aspect of invention, the system chooses the optimal resource allocation decision rule D (A) for EMO to be implemented by evaluating the influence of a-posteriori parameters B in a form of a guaranteed result principle (Minimax Criterion) in accordance with the formula:

$${min}_{Bε \hat{B}} W [ {D}^{*} ( A , B ) ] = {max}_{Dε \hat{D}} {min}_{Bε \hat{B}} W [ D ( A , B ) .$$

According to still another aspect of invention, the system chooses the optimal resource allocation decision rule D*(A) for EMO to be implemented by evaluating the influence of a-posteriori parameters B in a form of optimal “physical mix” \overline{D}*(A) in accordance with the formula:

$${\overline{D}}^{*} ( A ) = {\int }_{Bε \hat{B}}^{} {D}^{*} ( A , B ) ⅆ F ( B ) , W [ {D}^{*} ( A ) ] = W [ {\overline{D}}^{*} ( A ) ] .$$

According to yet another aspect of the invention, the system defines the number of expendable resources units n*ₛ used in EMO number “s” by the formula:

$${n}_{s}^{*} = const = \frac{{n }_{\sum }}{\overline{k}} , ∀ s ∈ \overline{1 , \overline{k}} ,$$

where

$$\overline{k} = {\int }_{0}^{∞} s ⅆ F ( s ) ,$$

and
F(s) is an a-priori law of distribution for parameter “s”,
under the restraint on expendable resources n_{Σ} available

$${\sum }_{i = 1}^{\overline{k}} {n}_{i} = {n}_{\sum } .$$

According to yet another aspect of the invention, the system defines the number of expendable resource units n*ₛ used in EMO number “s” by the formula:

$${n}_{s}^{*} = \frac{{n}_{\sum }}{{\overline{k}}_{s}} ,$$

where

$${\overline{k}}_{s} = {\sum }_{k = s}^{∞} kP ( {H}_{k} / {A}_{s} ) . \\ P ( {H}_{k} / {A}_{s} ) = \{ \begin{matrix}\frac{P ( {H}_{k} )}{{\sum }_{i = 1}^{∞} P ( {h}_{i} )} , k ∈ \overline{s , ∞} \\ 0 , k ∈ \overline{0 , s - 1}\end{matrix}$$

P(Hₖ)—a prior probability of the hypothesis Hₖ (an exact number of EMO to happen is k), and
P(Hₖ/Aₛ)—a posterior conditional probability of the hypothesis Hₖ under condition of Aₛ (“s” EMO had happened already).

According to still another aspect of invention, the system defines the number of expendable resources units n*ₛ used in EMO number “s” by the formula:

$${n}_{s}^{*} = \frac{{n}_{\sum } {\sum }_{i = 1}^{s - 1} {n}_{i}^{*}}{{\overline{k}}_{s} - s + 1} = {n}_{\sum } \frac{1 - {\sum }_{i = 1}^{s - 1} \frac{1}{{\overline{k}}_{i}}}{{\overline{k}}_{s} - s + 1} .$$

According to another aspect of the invention, the system defines the number of expendable resources units n*ₛ used in EMO number “s” by the formula:

$${n}_{s}^{*} = const = \frac{{n}_{\sum }}{\tilde{k}} , ∀ s ∈ \overline{1 , \tilde{k}} , \\ where$$

$$\tilde{k} = index {max}_{j ∈ \overline{1 , ∞}} P ( {A}_{j} ) , and$$

P (Aₛ) is a prior probability for an exact number “s” of EMO to happen.

According to another aspect of the invention, the system defines the number of expendable resources units n*ₛ used in EMO number “s” by the formula:

$${n}_{s}^{*} = \frac{{n}_{\sum }}{{\tilde{k}}_{s}} , \\ where {\tilde{k}}_{s} = index {max}_{j ∈ \overline{s , ∞}} P ( {H}_{J} / {A}_{S} ) .$$

According to another aspect of the invention, the system defines the number of expendable resource units n*ₛ used in EMO number “s” by the formula:

$${n}_{s}^{*} = \frac{{n}_{\sum } - {\sum }_{i = 1}^{s - 1} {n}_{i}^{*}}{{\tilde{k}}_{s} - s + 1} = {n}_{\sum } \frac{1 - {\sum }_{i = 1}^{s - 1} \frac{1}{{\tilde{k}}_{i}}}{{\tilde{k}}_{s} - s + 1} .$$

According to still another aspect of the invention, the system defines the number of expendable resources units n*ₛ used in EMO number “s” by the formula:

$${n}_{s}^{*} = const = \frac{{n}_{\sum }}{{k}^{Γ}} , ∀ s ∈ \overline{1 , {k}^{Γ}} , F ( {k}_{Γ} ) = {α}_{Γ} ,$$

where α—a confidence level for guaranteed result (may be considered 0.90; 0.95; 0.99; etc),
k—a number of EMO that will happen with a confidence level equal to α.

According to still another aspect of the invention, the system defines the number of expendable resources units n, used in EMO number “s” by the formula:

$${n}_{s}^{*} = \frac{{n}_{\sum }}{{k}_{s}^{Γ}} ,$$

where k_{S} should be found from a relation

$${\sum }_{k = s}^{{k}_{S}^{Γ}} P ( {H}_{k} / {A}_{S} ) = {α}_{Γ} .$$

According to another aspect of the invention, the system defines the number of expendable resources units nₛ used in EMO number “s” by the formula:

$${n}_{s}^{*} = \frac{{n}_{\sum } - {\sum }_{i = 1}^{s - 1} {n}_{i}^{*}}{{k}_{s}^{Γ} - s + 1} = {n}_{\sum } \frac{1 - {\sum }_{i = 1}^{s - 1} \frac{1}{{k}_{i}^{Γ}}}{{k}_{s}^{Γ} - s + 1} .$$

According to another aspect of the invention, the system defines the number of expendable resources units nₛ used in EMO number “s” by the formula:

$${n}_{S}^{*} = const = {n}_{\sum } {\sum }_{k = 1}^{∞} \frac{1}{k} P ( {H}_{k} ) .$$

According to another aspect of the invention, the system defines the number of expendable resources units nₛ used in EMO number “s” by the formula:

$${n}_{S}^{*} = {n}_{\sum } {\sum }_{k = s}^{∞} \frac{1}{k} P ( {H}_{k} / As ) .$$

According to another aspect of the invention, the system defines the number of expendable resources units nₛ used in EMO number “s” by the formula:

$${n}_{S}^{*} = ( {n}_{\sum } - {\sum }_{i = 1}^{s - 1} {n}_{i}^{*} ) {\sum }_{k = s}^{∞} \frac{1}{k} P ( {H}_{k} / {A}_{S} ) = {n}_{\sum } [ 1 - {\sum }_{i - 1}^{s - 1} {\sum }_{k = 1}^{∞} \frac{1}{k} P ( {H}_{k} / {A}_{i} ) ] {\sum }_{k = s}^{∞} \frac{1}{k} P ( {H}_{k} / {A}_{S} ) .$$

### BRIEF DESCRIPTION OF THE DRAWINGS

The objects, features and advantages of the present invention will become more apparent from the following detailed description of the preferred embodiments thereof, taken in conjunction with the accompanying drawings, in which:

FIG. 1 is a block diagram of a system according to the invention;

FIG. 2 is a flow chart illustrating the method of the preferred embodiment;

FIG. 3 illustrates a comparative example of different optimal resource allocations for a particular IM operation; and

FIG. 4 illustrates a comparative example of resulting values for the optimality criterion (number of successful EMO) for the same IM operation.

### DETAILED DESCRIPTION OF THE PREFERRED EMBODIMENTS

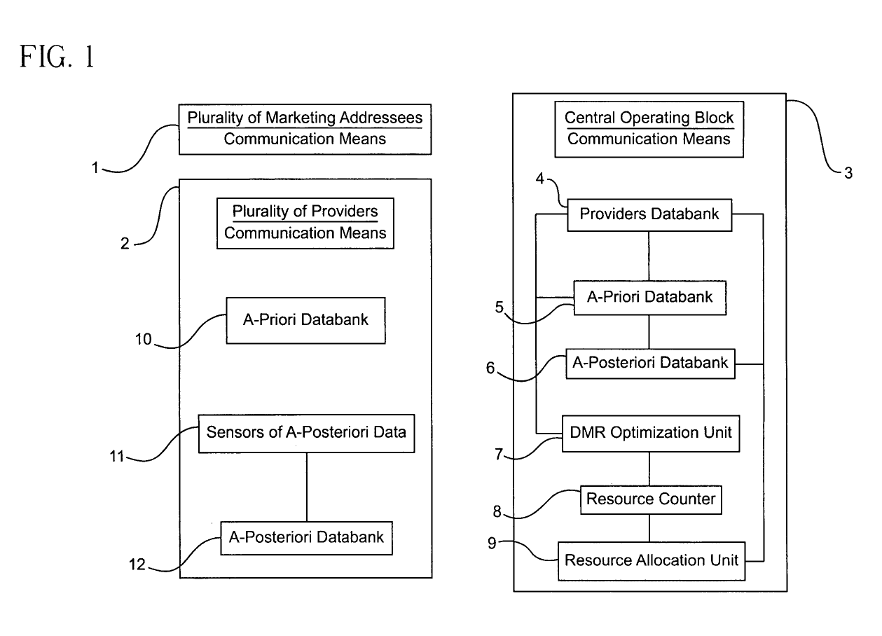

Turning now to a detailed consideration of a preferred embodiment of the present invention, FIG. 1 illustrates a greatly simplified block diagram of the primary elements of the computer-based system, which is employed for carrying out the method of the present invention.

The computer-based system includes a plurality of potential marketing addressees' computer terminals 1 with their communication means (i.e., modem and phone line with possibilities to be connected with other parts of the system through the Internet), a plurality 2 of IM providers hosted over the Internet with their communication means, and finally a central operating block 3 with its communication means, whose activities are designated for combining the system to function as a whole creation rather than a simple collection of the independent elements.

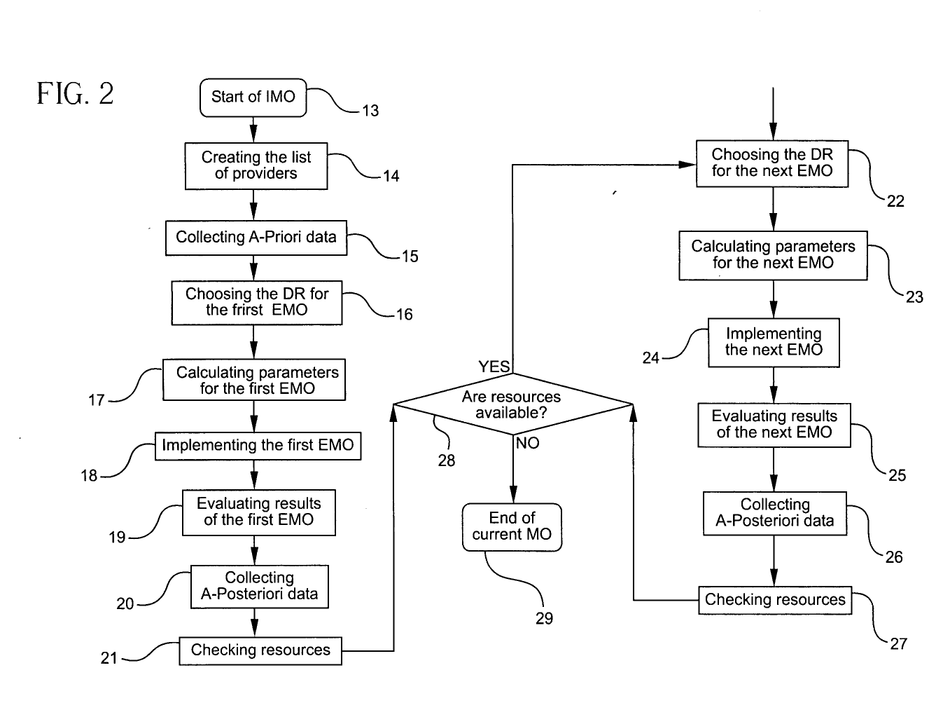

The mission of the whole system may be described by the steps illustrated in the simplified flowchart of the preferred embodiment in FIG. 2:
after establishing the initial interactive contact with the potential IM providers 2 through the communication means over the Internet (position 13 in FIG. 2) the system creates the list of IM providers to be considered (being part of the central operating block 3 as it is shown in FIG. 1 the providers databank 4 is responsible for fulfilling that step)—position 14 in FIG. 2;
the system collects from IM providers 2 the a-priori data about EMO available for implementation and resource-dependant effectiveness of these EMO (being the part of the central operating block 3 as it is shown in FIG. 1 the a-priori databank 5 being connected over the Internet with a-priori databanks 10 of IM providers 2 is programmed to fulfill that step)—position 15 in FIG. 2;
on the basis of information delivered from the a-priori databank 5, the system chooses the optimal resource allocation DMR for EMO to be implemented (being the part of the central operating block 3 as it is shown in FIG. 1, the DMR optimization unit 6 is programmed to fulfill that step as described in detail below) and calculates optimal resource-dependant effectiveness parameters for the first EMO (being the part of the central operating block 3 as it is shown in FIG. 1, the resource allocation unit 7 is programmed to fulfill this step as described in detail below)—positions 16-17 in FIG. 2;
system implements the first EMO, evaluates its results through direct or indirect (using IM provider 2 with its sensors of a-posteriori data 11 and a-posteriori databank 12 as intermediary) Internet contact with marketing addressees who responded for the first EMO thus collecting a-posteriori data on EMO effectiveness (being the part of the central operating block as it is shown in FIG. 1, the a-posteriori databank 8 is programmed to fulfill this step as described in detail below)—positions 18-20 in FIG. 2;
system checks the current status of resources available and proceeds according to recommendations of optimal DR chosen previously to the next EMO if resources are available, or ends the current IM operation otherwise (being the part of the central operating block 5 as it is shown in FIG. 1, the resource counter 9 is programmed to fulfill this step as described in detail below)—positions 21-22, 28-29 in FIG. 2;
system calculates optimal resource-dependant effectiveness parameters for the next EMO, implements the next EMO, and evaluates its results through direct or indirect (using IM provider with its sensors of a-posteriori data 11 and a-posteriori databank 12 as intermediary) Internet contact with marketing addressees who responded for that EMO thus collecting a-posteriori data on EMO effectiveness (for the implementation of this step the aforementioned resource allocation unit 7 and a-posteriori databank 8 are responsible)—positions 23-26 in FIG. 2;
system recurrently returns to two previous steps of the procedure (being the part of the central operating block 3 as it is shown in FIG. 1, the aforementioned resource counter 9 is programmed to fulfill this step)—positions 27-29 in FIG. 2.

Having in mind the whole described process, it is now possible to define the details and the variants of the procedure for the each specific step.

We presume existence of some optimality criterion W, to attain the maximal value W*, of which constitutes the goal of the operational party in the whole marketing operation. That criterion may have an evident practical sense (like mathematical expectation of the new clients acquired) or just may describe a utility function of the operational party on the set of the possible operation results.

Therefore, optimal DMR D*(A, B) should satisfy the relation

$$W [ {D}^{*} ( A , B ) ] = {max}_{Dε \hat{D}} W [ D ( A , B ) ] , \qquad ( 1 )$$

where
vector-function D (A, B) describes possible strategies of the operational party on the basis of usage of both a-priori (A) and a-posteriori (B) known information,
\hat{D}—the functional space of the admissible DMR D.

The DMR defined by (1) is completely evident and does not need any special grounding. Nonetheless, the direct implementation of that principle presumes one-step and full-volume delivery of a posteriori information B, followed by a decision making act (one-step as well) afterwards. In that particular setting, the difference between a priori A and a posteriori B information practically disappears. Attempts to resolve problems, which are connected with the gradualness of a posteriori information delivery accompanied by multi-step decision making, may be done from different positions.

In particular, if an a priori law of distribution F(B) for a posteriori evaluated parameters B is known, the influence of these parameters may be considered in average:

$$W [ {D}^{*} ( A ) ] = {max}_{Dε \hat{D}} {\int }_{Bε \hat{B}} W [ D ( A , B ) ] ⅆ F ( B ) , \qquad ( 2 )$$

where \tilde{B} is a set of possible values for a posteriori evaluated parameters.

It is also possible to consider a most probable value of B, or the value B, which is equal to a mode of the distribution F(B). Then

$$W [ {D}^{*} ( A ) ] = {max}_{Dε \hat{D}} W [ D ( A , \tilde{B} ) ] . \qquad ( 3 )$$

One more DMR uses the concept of optimal “physical mix” \overline{D}*(A) (as an analog of mixed strategy in game theory):

$${\overline{D}}^{*} ( A ) = {\int }_{Bε \hat{B}}^{} {D}^{*} ( A , B ) ⅆ F ( B ) , W [ {D}^{*} ( A ) ] = W [ {\overline{D}}^{*} ( A ) ] . \qquad ( 4 )$$

Finally, orientation on a guaranteed result principle (Minimax Criterion) is providing a relation

$${min}_{Bε \hat{B}} W [ {D}^{*} ( A , B ) ] = {max}_{Dε \hat{D}} {min}_{Bε \hat{B}} W [ D ( A , B ) . \qquad ( 5 )$$

Using adaptation ideas, it is possible to construct different modifications of DMR (2)-(5) with respect to the gradual improvement of informational status for the operational party, and to the gradual improvement of DMR itself.

A corresponding modification for an averaging DMR (2) may be implemented on a basis of the next considerations. Let's consider a sequence of a process time moments, numbered 1, 2, . . . , k Let a set B of vectors B to be a Decart product of sets \hat{B}ⱼ (where Bⱼε\hat{B}ⱼ designates a vector of parameters a posteriori evaluated at the moment j of the process time):
\hat{B}=\hat{B}₁×\hat{B}₂× . . . ×\hat{B}ₖ.

Let a vector-function D consist of a batch of vector-functions D₁, D₂, . . . , Dₖ, written down in an order of the process time passing and operational party decision making in accordance with changes of a posteriori information B. At the moment when decision Dᵢ is taking place, there is a full information about all vectors Bⱼ⊂B, ∀ⱼ<i, where B=(B₁, B₂, . . . , Bₖ). Further, while analyzing particular DMR implementations, we will see how lack of the “ideal” process memory (full information about what has happened so far) would affect the results. At the moment, when D₁ should be made, only an a priori law of distribution is presumed to be known about B:
F(B)=F₁(B₁,B₂, . . . ,Bₖ). (6)

After D₁ has been made, a particular value of B₁=\overline{B}₁ is becoming available, and before making D₂, function (6) should be replaced with its a posteriori evaluation:
F(B/B₁=\overline{B}₁)=F₂(B₂, . . . ,Bₖ/B₁=\overline{B}_{1).}

Similarly, on the step number “s” of the procedure and before making decision Dₛ, an a posteriori evaluation of Fₛ, should be done as follows:
F(B/Bᵢ=\overline{B}ᵢ,∀i≦s−1)=Fₛ(Bₛ, . . . ,Bₖ/Bₖ=Bᵢ=\overline{B}ᵢ∀i≦s−1). (7)

Finally, decision Dₖ should be done on the basis of evaluation
Fₖ(Bₖ/Bᵢ=\overline{B}ᵢ,∀i≦k−1).
In many cases, information about Bᵢ may not be complete or presented precisely. There could be some stochastic elements with distribution functions Φᵢ(Bᵢ) in it, or elements of a “pure” uncertainty, when the only determination available is Bᵢε\hat{B}ᵢ. Nevertheless, if any elaboration of (7) on the basis of that imperfect a posteriori information about Bᵢ is available, such elaboration should be done.

In that case, optimal in average DMR has the structure
D={Dᵢ(Dⱼ,\overline{B}ⱼ,∀j<i),∀j≦k}, (8)
and may be defined as a result of the following multi-step procedure (type of dynamic programming calculation procedure).

An optimal D*ₖ(D₁, . . . ,Dₖ₋₁, \overline{B}₁, . . . , \overline{B}ₖ₋₁) is to be found from the relation

$${\int }_{{B}_{k} ε {\hat{B}}_{k}}^{} W ( {D}_{1} , … , {D}_{k - 1} , {D}_{k}^{*} , {\overline{B}}_{1} , … , {B}_{k} ) {dF}_{k} ( {B}_{k} / {B}_{i} = {\overline{B}}_{i} , ∀ i \leq k - 1 ) = {max}_{{D}_{k} ε {\hat{D}}_{k}} {\int }_{{B}_{k} ε {\hat{B}}_{k}} W ( {D}_{1} , … , {D}_{k - 1} , {D}_{k} , {\overline{B}}_{1} , … , {B}_{k} ) ⅆ {F}_{k} ( {B}_{k} / {B}_{i} = {\overline{B}}_{i} , ∀ i \leq k - 1 ) . \qquad ( 9 )$$

An optimal D*ₖ₋₁(D₁, . . . , Dₖ₋₂, \overline{B}₁, . . . , \overline{B}ₖ₋₂) is to be found from the relation

$${\int }_{{B}_{k} ∈ {\hat{B}}_{k} , {B}_{k - 1} ∈ {\hat{B}}_{k - 1}} W ( {D}_{1} , … , {D}_{k - 2} , {D}_{k - 1}^{*} , {D}_{k}^{*} , {\overline{B}}_{1} , … , {B}_{k} ) ⅆ {F}_{k - 1} ( {B}_{k} , {B}_{k - 1} / {B}_{i} = {\overline{B}}_{i} , ∀ i \leq k - 2 ) = \\ = {max}_{{D}_{k - 1} ∈ {\hat{D}}_{k - 1}} {\int }_{{B}_{k} ∈ {\hat{B}}_{k} , {B}_{k - 1} ∈ {\hat{B}}_{k - 1}} W ( {D}_{1} , … , {D}_{k - 1} , {D}_{k}^{*} , {\overline{B}}_{1} , … , {B}_{k} ) ⅆ {F}_{k - 1} ( {B}_{k} , {B}_{k - 1} / {B}_{i} = {\overline{B}}_{i} , ∀ i \leq k - 2 ) . \qquad ( 10 )$$

The k-step recurrent process defined in (9)-(10) is to be finished (in a real time it will in fact be started) by calculation D*₁ from the relation

$${\int }_{B ∈ \hat{B}} W ( {D}_{1}^{*} , {D}_{2}^{*} , … , {D}_{k}^{*} , {B}_{1} , … , {B}_{k} ) ⅆ {F}_{1} ( {B}_{1} , … , {B}_{k} ) = \\ = {max}_{{D}_{1} ∈ {\hat{D}}_{1}} {\int }_{B ∈ \hat{B}} W ( {D}_{1} , {D}_{2}^{*} , … , {D}_{k}^{*} , {B}_{1} , … , {B}_{k} ) ⅆ {F}_{1} ( {B}_{1} , … , {B}_{k} ) {=}^{Δ} W ( {D}^{*} ) . \qquad ( 11 )$$

There are evident changes to be done in (8)-(11) in the case when a DMR should be optimized not in average but for the most probable values \tilde{B} of relevant parameters Bε\hat{B}. A decision to implement Dₛ is to be done on the basis of an a posteriori evaluation for probability distribution law Fₛ(B) given in (7). To do this, it is necessary to define the most probable set ₛ=(\overline{B}₁, . . . ,\overline{B}ₛ₋₁,\tilde{B}ₛ,\tilde{B}ₛ₊₁, . . . ,\tilde{B}ₖ), which is equal to a mode of the distribution Fₛ(B). An optimal D*₅(D₁, . . . ,D_{S-1},\overline{B}₁, . . . ,\overline{B}ₛ₋₁) is to be found from the relation

$${W}_{s + 1} ( {D}_{1} , … , {D}_{s - 1} , {D}_{s}^{*} , {\tilde{B}}_{s} ) = {max}_{{D}_{s} ∈ {\hat{D}}_{s}} {W}_{s + 1} ( {D}_{1} , … , {D}_{s - 1} , {D}_{s} , {\tilde{B}}_{s} ) , \\ where \\ {W}_{s + 1} ( {D}_{1} , … , {D}_{s} , {\tilde{B}}_{s} ) {=}^{Δ} W ( {D}_{1} , … , {D}_{s} , {D}_{s + 1}^{*} , … , {D}_{k}^{*} , {\tilde{B}}_{s} ) . \qquad ( 12 )$$

An optimal guaranteed (Minimax) DMR presumes that at the moment of making decision Dₛ the operational party has information only about the set \hat{B}ₛ, where parameters Bₛ are belonging. The guaranteed (worst possible) values of parameters Bᵢ^{G}ε\hat{B}ᵢ, ∀i≦s−1, which have been defined at the previous steps of decision making are presumed to be known as well.

Then an optimal DMR D*ₛ(D₁, . . . ,Dₛ₋₁,B₁^{G}, . . . ,Bₛ₋₁^{G}) is to be found from the relation

$${min}_{{B}_{s} ∈ {\hat{B}}_{s}} {W}_{s + 1} ( {D}_{1} , … , {D}_{s - 1} , {D}_{s}^{*} , {B}_{1}^{G} , … , {B}_{s} ) = {max}_{D ∈ {\hat{D}}_{s}} {min}_{{B}_{s} ∈ {\hat{B}}_{s}} {W}_{s + 1} ( {D}_{1} , … , {D}_{s} , {B}_{1}^{G} , … , {B}_{s} ) . \qquad ( 13 )$$

The procedures of optimization in average (9)-(11), in a most probable case (12), and guaranteed (13), which have been discussed so far, are destined for use of nonrandomized DMR. The presence of some other operational parties (competitors, official regulators, service providers etc.) is not always pleasant but an indisputable fact of life in any real marketing campaign. The tendency to describe a process of Internet Marketing more or less adequately should, therefore, include some game models (at least in a form of games with a nature). In our formal description, strategies of these other operational parties are part of the set B as well. The best methodical treatment for that kind of situation is offered by the game theory and presumes an introduction of some probabilistic measure in the space \hat{D}—that means making transitions to randomized DMR.

The simplest form of randomization entails evident (in formal sense) transformations of DMR:
instead of optimal (in one sense or another) DMR D*, an optimal distribution law Φ*(D), Dε\hat{D} should be found;
instead of initial criterion function W(D), its average over the measure Φ(D) should be considered as a formal description of the operational party preferences:

$$W = {\int }_{D ∈ \hat{D}} W ( D ) ⅆ Φ ( D ) . \qquad ( 14 )$$

As is well known, an operational party in a game theory situation is not always ready to use mixed strategies (randomized DMR are the evident equivalents of the mixed strategies in a classical game), not even if formal averaging in (14) results in some enhancements of W values. The reason for such a position has a simple explanation: enhancements may be relevant only regarding averages, after a large number of realizations have been implemented. A risk of substantial losses is present in every particular realization. Finally, if operational parties have full information about particular realizations of each other's strategies, the usage of randomized DMR is senseless.

The concept of a physical mix for DMR may become useful in that kind of a situation, if its particular realization is available for implementation. Constructing optimal DMR in a form of a physical mix also presumes the usage of an a posteriori evaluation for probability distribution law Fₛ(B) given in (7). In that case, at the step number “s” of the procedure, an optimal DMR

$${D}_{s}^{*} = {\int }_{{D}_{s} ∈ {\hat{D}}_{s}} {D}_{s} ⅆ {Φ}^{*} ( {D}_{s} ) = {D}_{s}^{*} ( {D}_{1} , … , {D}_{s - 1} , {\overline{B}}_{1} , … , {\overline{B}}_{s - i} )$$

is to be found from the relation

$${W}_{s + 1} ( {D}_{1} , … , {D}_{s - 1} , {D}_{s}^{*} , {\overline{B}}_{1} , … , {\overline{B}}_{s - 1} ) == \\ {max}_{{{Φ}_{s} ( {D}_{s} ) ,}_{{D}_{s} ∈ {\hat{D}}_{s}}} \{ {\int }_{{B}_{j} ∈ {\hat{B}}_{j}} {W}_{s + 1} [ {D}_{1} , … , {D}_{s - 1} , {\int }_{{D}_{s} ∈ {\hat{D}}_{s}} {D}_{s} ⅆ {Φ}_{s} ( {D}_{s} ) , {\overline{B}}_{1} , … , {B}_{k} ) ⅆ {F}_{s} ( {B}_{j} / {B}_{i} = {\overline{B}}_{i} , ∀ j ∈ \overline{s , k} , ∀ i ∈ \overline{1 , s - 1 ) ] \} .} \qquad ( 15 )$$

An a posteriori information change in (15) has to be described in average, using the measure Fₛ(B), because physical mix DMR is not delivering any enhancement in the criterion (14) for guaranteed and most probable cases.

Previous results have been formulated for the case when an operational party is using one and only one DMR for all steps “s” of the marketing operation, sε\overline{1,k}. Nevertheless, an operational party may interchange different DMR for different steps, if there are some good thoughtful reasons for that. A step-by-step interchange of DMR may create a vast diversity of DMR structures, but formal description of that diversity could always be created as an evident combination of results (8)-(15).

Enhancement of a priori data on the basis of new information collected at the process of Internet Marketing operation is one of the crucial moments in DMR construction. An adequate methodical tool of such enhancement (at least in part of delivering a posteriori distribution laws Fₛ(B)) may be found in well known Bayesian Decision Theory (BDT)—see, for example, Gelman, A., Carlin, J., Stern, H. and Rubin, D. (2003) Bayesian Data Analysis, CRC Press, Boca Raton, 255 pp, the disclosure of which is incorporated herein by reference.

Some very strong simplifying assumptions will be done here just to show logic foundations of DMR construction using BDT. Nevertheless, the exemplified situation does not forfeit any practical value and may be described as follows.

An operational party has an a priori knowledge of parameters for EMO distribution law. That law is presumed to be normal and thus may be fully described with two numbers: an average and a dispersion for the number of EMO to be implemented.

The operational party goal is to allocate some budget (money, number of expendable resources) to different EMO. Expendable resources are presumed to be homogeneous (having equal effectiveness), independently acting and unlimitedly divisible (optimal solution is not obligated to be integer).

When the operational party has full and authentic information about the number of EMO to be implemented, an optimal a priori DMR is evident and presumes an even allocation of expendable resources in between EMO. If a probability of success (for example, probability to register a new customer) is p¹ for one unit of expendable resources used, then in the case when n units of expendable resources are used in a same EMO, due to independence of resource acting, a probability of success pⁿ is to be given by the relation:
pⁿ=1−(1−p¹)ⁿ.

Finally, an average number of new customers registered after k EMO had been implemented is given by the relation:

$${N}_{\sum } = {\sum }_{i = 1}^{k} [ 1 - {( 1 - {p}^{1} )}^{{n}_{i}} ] , \qquad ( 16 )$$

where nᵢ is the number of expendable resources units used in EMO number i.

Now it is evident that under the restraint on expendable resources n_{Σ} available

$${\sum }_{i = 1}^{k} {n}_{i} = {n}_{\sum } \qquad ( 17 )$$

function (18) has an extreme value (maximum) when

$${n}_{i}^{*} = {n}^{*} = const = \frac{{n}_{\sum }}{k} , ∀ i ∈ \overline{1 , k} . \qquad ( 18 )$$

There are some possibilities to overturn the simplifying assumptions done in (16)-(18).

A hypothesis about normal law of EMO number distribution have already been discussed and is introduced here exclusively in connection with a convenience to define that law entirely with two numerical characteristics. What is really important here is only a possibility for an operational party to choose any particular a priori law of distribution for vector B.

An assumption about homogeneity and independence of action for expendable resources units is the only justification in delivering a simple analytical solution (18) for the optimization problem (16)-(17). Rejection of those two assumptions makes it necessary to resolve an optimization problem numerically and to receive a result as follows:
n*ᵢ=n*ᵢ(n_{Σ},k,pᵢ(nᵢ)),∀iε1,k,
where pᵢ(nᵢ) describes the efficiency of nᵢ expendable resource units used in EMO number i.

In fact, optimal solution (18) is valid when instead of independence assumption (16) the more common assumption about monotone uniform growth of N_{Σ} as a function of nᵢ, ∀iε\overline{1,k}, is made.

Special attention should be paid to the possibility of getting an integer solution to optimization problem (19). When actual values of nᵢ are big enough (measured in dozens), it is possible to disregard rounding off errors while not losing much in the value of the optimality criterion. If a rounding off is taking place for some numbers n*ᵢ, it should be done, for example, in an increasing direction for first the j* numbers of EMO and in a decreasing direction for other k−j* numbers of EMO, where

$${\sum }_{i = 1}^{{j}^{*}} {n}_{i}^{*} - [ {n}_{i}^{*} ] \approx {\sum }_{i = {j}^{*} + 1}^{k} {n}_{i}^{*} - [ {n}_{i}^{*} ] , \qquad ( 20 )$$

and [n,] is the nearest integer number (from the left) to nᵢ.

The relation (20) describes an evident tendency of any operational party to resolve more successfully first problems met in comparison with some commensurable problems to be met somewhere in the future.

A strict formulation of an integer optimization problem delivers some additional complications to (19) elaboration, but does not change DMR construction procedures in principle. These procedures just presume availability of solutions for all optimization problems involved. A particular form of an optimal decision does not play an essential role for the following analysis. Therefore only the simplest form (18) will be taken into consideration.

An operational party is presumed to have knowledge of an a priori distribution law F(k) for a number k of EMO that is expected to happen. Then a prior probability P(s) for an exact number s of EMO to happen is given by the relation:
P(s)=F(s+1)−F(s−1). (21)
The next notations will be used further:
P(Hₖ)—a prior probability of the hypothesis Hₖ (an exact number of EMO to happen is k), which is defined by the relation (21);
P(Aₛ/Hₖ)—a prior conditional probability of EMO number s to happen under condition Hₖ;
P(Hₖ/Aₛ)—a posterior conditional probability of the hypothesis Hₖ under condition of Aₛ(“s” EMO had happened already).
Introduced probabilities are connected in a Bayes' formula:

$$P ( {H}_{k} / {A}_{s} ) = \frac{P ( {H}_{k} ) P ( {A}_{s} {H}_{i} )}{{\sum }_{i = 0}^{∞} P ( {H}_{i} ) P ( {A}_{s} / {H}_{i} )} . \qquad ( 22 )$$

Furthermore, the next obvious relations are taking place:
P(Hₖ/Aₛ)=1, ∀kε\overline{s,∞},
P(Hₖ/Aₛ)=0, ∀kε\overline{0,s−1}.
Then (22) may be rewritten in a form:

$$P ( {H}_{k} / {A}_{s} ) = \{ \frac{P ( {H}_{k} )}{{\sum }_{i = s}^{∞} P ( {h}_{i} )} , k ∈ \overline{s , ∞} \qquad ( 23 )$$

0,kε\overline{0,s−1}

Relation (23) will be used further on as an a posteriori evaluation for a probability Pₛ (Hₖ). It is simple to conclude, that as

$${\sum }_{i = s}^{∞} P ( {H}_{i} )$$

decreases with an increase of s, a value of Pₛ(H^{k}) droningly increases, but stays less than 1, since P(Hₖ) is just one of the summands in

$${\sum }_{i = s}^{∞} P ( {H}_{i} ) .$$

Different variants of DMR are possible using an a priori DMR (18) as a basic construction, relation (23) as a tool of a posteriori evaluation for parameter k, and different DMR structures.

A refusal to use a-posteriori information delivers an optimal in average a priori DMR:

$${n}_{s}^{*} = const = \frac{{n}_{\sum }}{\overline{k}} , ∀ s ∈ \overline{1 , \overline{k}} , \qquad ( 24 )$$

where

$$\overline{k} = {\int }_{0}^{∞} s ⅆ F ( s ) ,$$

and
n_{Σ}—a whole budget of expendable resource units available for allocation in an operation.
Optimal in average DMR may also be constructed on the basis of an a posteriori evaluation \overline{k}ₛ for the parameter \overline{k}:

$${\overline{k}}_{s} = {\sum }_{k = s}^{∞} kP ( {H}_{k} / {A}_{s} ) . \qquad ( 25 )$$

There are two possible ways to calculate an optimal resource allocation here:

$${n}_{s}^{*} = \frac{{n}_{\sum }}{{\overline{k}}_{s}} , \qquad ( 26 )$$

and

$${n}_{s}^{*} = \frac{{n}_{\sum } - {\sum }_{i = 1}^{s - 1} {n}_{i}^{*}}{{\overline{k}}_{s} - s + 1} = {n}_{\sum } \frac{1 - {\sum }_{i = 1}^{s - 1} \frac{1}{{\overline{k}}_{i}}}{{\overline{k}}_{s} - s + 1} . \qquad ( 27 )$$

In a first of those rules (DMR without memory (26)) information about previous optimal decisions n*ᵢ, ∀iε\overline{1,s−1} is not necessary, in a second rule (DMR with ideal memory or an adaptive one—(27)) that information should be memorized and used. In both cases, the budget of expendable allocation resources will be exhausted after k EMO, where a number k may be found from a relation:

$${\sum }_{i = 1}^{k} {n}_{i}^{*} ≅ {n}_{\sum } , \qquad ( 28 )$$

and particular values for k from (28) may be different for DMR (26) and (27). Some evident changes in DMR (24), (26) and (27) should be made for optimization in a most probable case. In (24) a value \overline{k} should be exchanged for a value \tilde{k} defined by a relation

$$\tilde{k} = index {max}_{j ∈ \overline{1 , ∞}} P ( {A}_{j} ) .$$

In (26) and (27), instead of values \overline{k}_{S}, the values \tilde{k}_{S} should be used, defined by the relation:

$${\tilde{k}}_{S} = index {max}_{j ∈ \overline{s , ∞}} P ( {H}_{j} / {A}_{S} ) .$$

Then we will get the next variants of DMR (24), (26), and (27) for optimization in a most probable case:

$$\begin{matrix}{n}_{s}^{*} = const = \frac{{n}_{\sum }}{\tilde{k}} , ∀ s ∈ \overline{1 , \tilde{k}} , & ( 24 a ) \\ {n}_{s}^{*} = \frac{{n}_{\sum }}{{\tilde{k}}_{s}} , & ( 26 a ) \\ {n}_{s}^{*} = \frac{{n}_{\sum } - {\sum }_{i = 1}^{s - 1} {n}_{i}^{*}}{{\tilde{k}}_{s} - s + 1} = {n}_{\sum } \frac{1 - {\sum }_{i = 1}^{s - 1} \frac{1}{{\tilde{k}}_{i}}}{{\tilde{k}}_{s} - s + 1} . & ( 27 a )\end{matrix}$$

For normal law of distribution optimal in a most probable case and in average a-priori DMR have coinciding optimal solutions. Optimal in a most probable case a-posteriori DMR also has coinciding optimal solutions with optimal in average APDMR for s≦\overline{k}, that means

$${\tilde{k}}_{s} = index {max}_{i ∈ \overline{s , ∞}} P ( {H}_{j} / {A}_{S} ) = \overline{k} , ∀ s \leq \overline{k} , \qquad ( 29 )$$

and for s>\overline{k} the next relation has place:

$${\tilde{k}}_{S} = index {max}_{j ∈ \overline{s , ∞}} P ( {H}_{j} / {A}_{S} ) = s , ∀ s > \overline{k} . \qquad ( 30 )$$

Relations (29)-(30) exhaust a subject of optimal in a most probable case DMR under a normal law of distribution F(k). For s≦\overline{k} they are equivalent to optimal in average DMR, and for s>\overline{k}, they lose any practical interest, because in the first DEMO after an optimal resource allocation of n*_{S}=n_{Σ}/\overline{k} have been done, there are no more resources available to allocate.

Modifications of DMR (24), (26), (27) for the case of a guaranteed (Minimax) optimization are simple. In (24), a value \overline{k}, should be changed for a value k, to be found from a relation
F(k)=α, (31)
where α is a confidence level for guaranteed result (may be considered 0,90; 0,95; 0,99; etc),
k—a number of EMO that will happen with a confidence level equal to α.

It is evident that k is droningly increasing with the growth of α.

Now (24) may be rewritten in a form:

$${n}_{s}^{*} = const = \frac{{n}_{\sum }}{{k}^{Γ}} , ∀ s ∈ \overline{1 , {k}^{Γ}} , F ( {k}_{Γ} ) = {α}_{Γ} . \qquad ( 32 )$$

In (26) and (27), instead of values \overline{k}_{S}, evaluations kₛ should be introduced, found from a relation

$${\sum }_{k = s}^{{k}_{s}^{Γ}} P ( {H}_{k} / {A}_{S} ) = {α}_{Γ} . \qquad ( 33 )$$

Now (26) and (27) may be rewritten in a form:

$$\begin{matrix}{n}_{s}^{*} = \frac{{n}_{\sum }}{{k}_{s}^{Γ}} , {\sum }_{k = s}^{{k}_{s}^{Γ}} P ( {H}_{k} / {A}_{S} ) = {α}_{Γ} , & ( 34 ) \\ {n}_{s}^{*} = \frac{{n}_{\sum } - {\sum }_{i = 1}^{s - 1} {n}_{i}^{*}}{{k}_{s}^{Γ} - s + 1} = {n}_{\sum } \frac{1 - {\sum }_{i = 1}^{s - 1} \frac{1}{{k}_{i}^{Γ}}}{{k}_{s}^{Γ} - s + 1} , {\sum }_{k = s}^{{k}_{s}^{Γ}} P ( {H}_{k} / {A}_{S} ) = {α}_{Γ} . & ( 35 )\end{matrix}$$

A confidence level value α may be considered variable for different values of s, if there are any thoughtful grounds for that.

It has been already mentioned that physical mixes of DMR are using a posteriori data in the same principal way as optimal in average DMR are. The only difference is that averaging by the hypothesis Hₖ should be done not before resource n_{Σ} allocation, but after that allocation has taken place. Therefore, equivalents of DMR (24), (26), (27) may be written in a form:

$$\begin{matrix}{n}_{S}^{*} = const = {n}_{\sum } {\sum }_{k = 1}^{∞} \frac{1}{k} P ( {H}_{k} ) , & ( 36 ) \\ {n}_{S}^{*} = {n}_{\sum } {\sum }_{k = s}^{∞} \frac{1}{k} P ( {H}_{k} / As ) , and & ( 37 ) \\ {n}_{S}^{*} = ( {n}_{\sum } - {\sum }_{i = 1}^{s - 1} {n}_{i}^{*} ) {\sum }_{k = s}^{∞} \frac{1}{k} P ( {H}_{k} / {A}_{S} ) = {n}_{\sum } ( 1 - {\sum }_{i - 1}^{s - 1} {\sum }_{k = 1}^{∞} \frac{1}{k} P ( {H}_{k} / {A}_{i} ) ) {\sum }_{k = s}^{∞} \frac{1}{k} P ( {H}_{k} / {A}_{S} ) . & ( 38 )\end{matrix}$$

All variants of DMR (24)-(38) have been constructed for a simple example of optimal resource allocation (18). The practical sense of that allocation has been already discussed; it made possible the explicit form of mathematical description for all variants of DMR, showing clearly their physical sense alongside their personal features; it will facilitate comparative analysis of DMR that will be further accomplished for one numerical example. A necessary condition for any DMR construction procedure is the availability of an optimal resource allocation algorithm, the use of which will result in generation of an optimal solution described by the common form (19). Afterwards, equivalents for DMR (24)-(38) may be created without any serious difficulties.

There were nine variants of formal structures for DMR considered so far (as is shown in Table 2). Optimal in a most probable case DMR are not shown here as far as they are coinciding with optimal in average DMR for normal law of distribution for a-priori and a-posteriori data.

TABLE 2
Variants of formal structure for DMR

| | | Data Used | | |
|---|---|---|---|---|
| | | | A Posteriori | A Posteriori |
| | | A Priori | w/o Memory | Adaptive |
| Optimality | Optimal in | (24) | (26) | (27) |
| Principle | Average | | | |
| | Guaranteed | (32) | (34) | (35) |
| | (Minimax) | | | |
| | Physically | (36) | (37) | (38) |
| | Mixed DMR | | | |

Three of the DMR here use only a priori data, three use a posteriori data but forfeit any memory of the process, and three use a posteriori data together with some adaptation features. Each of the groups is formed by three DMR—an optimal guaranteed DMR, an optimal in average DMR and a physical mix of DMR, using an optimal in average randomization. Nevertheless, the question—what DMR should be used in this or that particular situation?—is staying unanswered.

General recommendations of operations research (as any other general recommendations) do not provide an exhaustive solution, although being definitely useful. If an operational party is cautious about risky decisions, the guaranteed DMR should be used. A-posteriori DMR are always more flexible and watchful, than a priori DMR; adaptive DMR in their turn are more flexible than DMR without memory, but the first ones are more complex in their implementation. The last comment is true not only in connection with guaranteed DMR, but may be relevant for other types of DMR as well.

When whole series of decisions should be made, and a result of each particular decision is not so significant in comparison with the overall amount of results, optimal in average DMR may be used. Finally, presence of a conscious competitor and possibility to keep secret a particular strategy implementation of an operational party are the main premises for preferable use of randomized DMR (and of physical mixes DMR, if they can be implemented in practice).

Comparatively small fuzziness of a priori data (there are just small uncertainties, dispersions of data are small in comparison with averages for a priori distribution laws) makes it impossible to use a-priori DMR successfully. When uncertainties increase, it is time to switch to posteriori DMR etc.

One may ask—does it make any sense to consider so many variants of DMR, some of which are not very simple in their construction and implementation? Exact or at least more definite recommendations on behalf of some particular DMR usage might be done only when specific features of the Internet marketing operation in question are known, but a simple example discussed below shows that at least seven different DMR (from nine DMR shown in Table 2) are optimal in some particular circumstances.

With the goal of investigating possible areas of recommended usage for different DMR, it makes sense to limit the scope of complexity for modeled EMO at the simplest level.

Having said this, we are going to use a relation (16) as a criterion function for an operation with an a priori average for EMO to be implemented kₐᵥ=5 and a dispersion Dₖ=σₖ²=1 under normal law of distribution. The budget of an operational party is equal to 10 units of expendable resources, n_{Σ}10, and we are going to limit the possible longevity of the simulated operation by 10 EMO as well. A probability of success p¹ for one unit of expendable resources used in an EMO is considered to be a variable and will be changing from 0 till 1 with 0.1 steps.

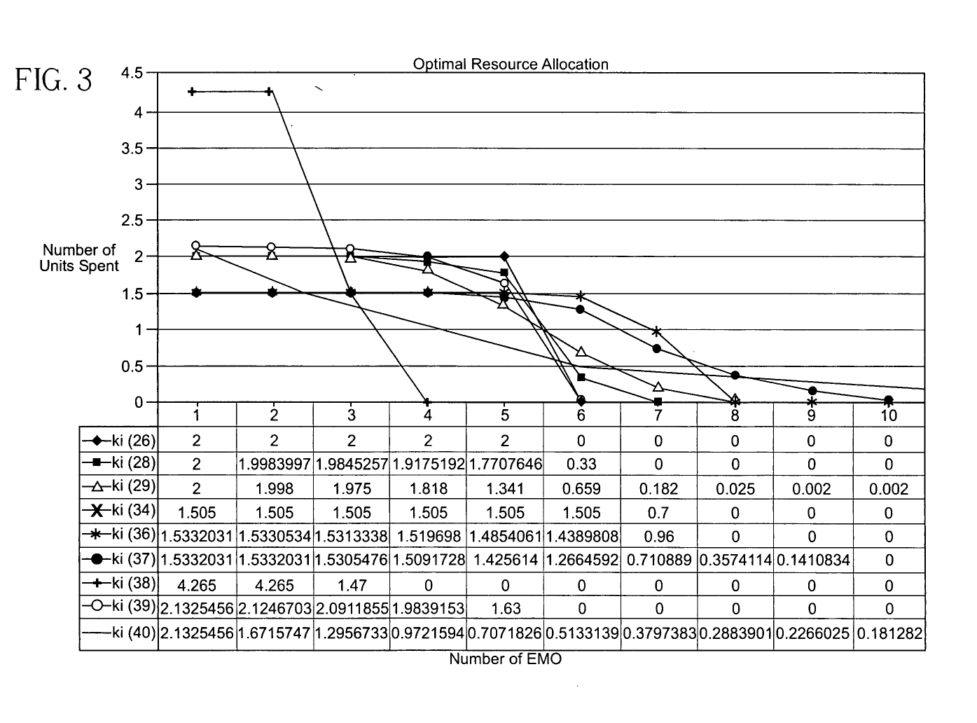

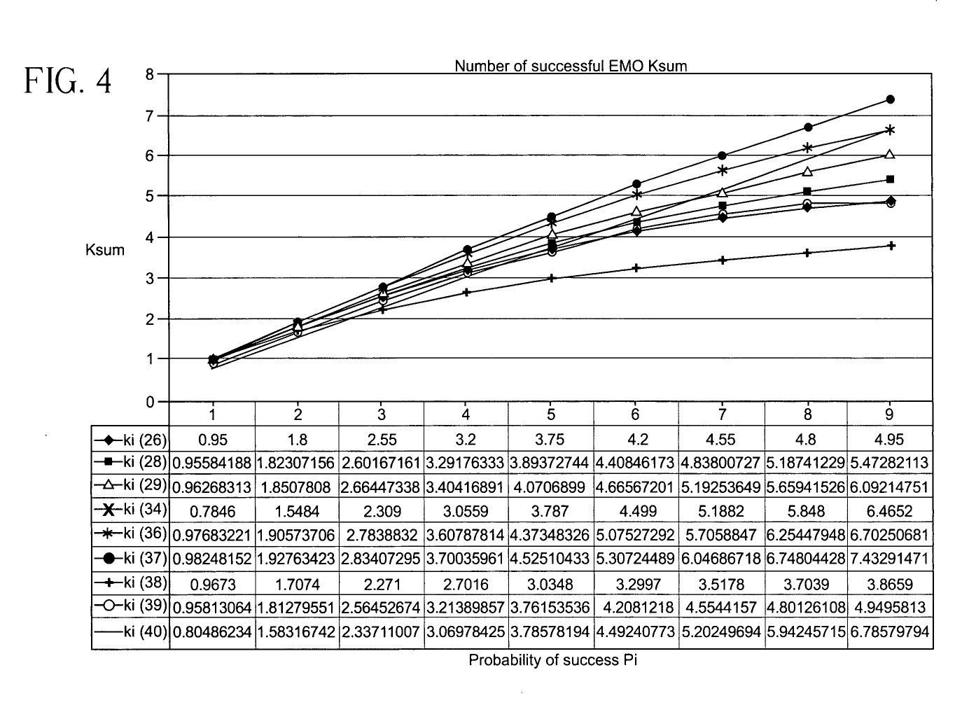

The optimal resource allocations under DMR from Table 2 are shown in FIG. 3 and the resulting values of the criterion (16) are shown on FIG. 4. The shortest life is destined to resources spent under a priori DMR (only three EMO have been served under the guaranteed DMR (32) while five EMO have been served under both optimal in average DMR (24) and physically mixed DMR (36)—see FIG. 3. The a posteriori adaptive DMR (27), (35), and (38), to the contrary, are the ones that show the ability to serve the maximal numbers of EMO. The physically mixed adaptive DMR (38) is a real champion in that sense—even after 10 EMO had taken place, all available resources had not been spent under that DMR. For the operation with 10 EMO to be implemented, the best DMR available are guaranteed adaptive DMR (35) (the optimal one), guaranteed a posteriori without memory DMR (34) (first sub-optimal), and optimal in average adaptive DMR (27) (second sub-optimal)—no matter what level of efficiency p¹ for one unit of expendable resources has taken place—see FIG. 4.

These recommendations of optimal and sub-optimal DMR are becoming much more complicated when the longitude of an operation is also considered as a variable that will be changed from 1 till 10 with the step equal to 1 (Table 3). Here, seven from nine DMR available are becoming strictly optimal (not just sub-optimal!) under some combinations of variables. For short operations (with less than average longitude) even a-priori DMR as (36) and (24) are optimal; but for longer operations the focus of optimality is moving to guaranteed a-posteriori DMR (34) and (35). Only DMR (32) and (38) are not considered optimal under any combinations of variables in this particular example.

TABLE 3
Optimal DMR for different final EMO number
K_{fin} and efficiency of a resource unit Pᵢ.
Optimal DMR

| Final | 1 | 36 | | 36 | | | | | | | | |
|---|---|---|---|---|---|---|---|---|---|---|---|---|
| EMO | 2 | | | | | | | | | | | |
| number, | 3 | | | | | | | | | | | |
| Kfin | 4 | | | 36 | | | 37 | | | | | |
| | 5 | | | 37 | | | | | | | 24 | |
| | 6 | | | 26 | | 27 | | 34 | | | | |
| | 7 | 34 | | | 34 | | | | | | | |
| | 8 | | | | 35 | | | | | | | |
| | 9 | 35 | | | | | | | | | | |
| | 10 | | | | | | | | | | | |
| | | 0+ | 0.1 | 0.2 | 0.3 | 0.4 | 0.5 | 0.6 | 0.7 | 0.8 | 0.9 | 1− |

Efficiency of a resource unit, Pi

The relative measure of the area occupied by particular DMR in Table 3 (presuming that the whole area is equal 100%) may be considered as a relative frequency of optimal use for that DMR. Simple calculations show that:
relative frequency of optimal use for all a priori DMR together [(24)+(32)+(36)] is 38%;
relative frequency of optimal use for all a posteriori DMR without memory together [(26)+(34)+(37)] is 32%;
relative frequency of optimal use for all a posteriori adaptive DMR together [(27)+(35)+(38)] is 30%;
relative frequency of optimal use for all optimal in average DMR together [(24)+(26)+(27)] is 6%;
relative frequency of optimal use for guaranteed DMR together [(32)+(34)+(35)] is 45%;
relative frequency of optimal use for all physically mixed DMR together [(36)+(37)+(38)] is 49%;
the second least popular DMR (after (32) and (38) that are not recommended for use in this particular example at all) are optimal in average DMR (24), (26), (27) with relative frequency of optimal use just 2% each; and
the most popular DMR is physically mixed a priori DMR (36) with relative frequency of optimal use 36%.

It is necessary to accentuate again here that all these numbers of optimal use frequencies are true just for intentionally and significantly simplified examples of simulated operation. Introduction of the much more complicated model (19) will change neither sense nor formal content of procedures, which should be implemented with the goal to get optimal use frequencies for such more complicated case—just the volume of necessary computations may grow tremendously.

Although the present invention has been disclosed in terms of is preferred embodiments, it will be understood that numerous variations and modifications could be made thereto without departing from the scope of the invention as set forth in the following claims. For example, the use of the Internet as a communication media is not unique—the whole procedure may also be ascertained through the usual phone lines, etc. So we are offering a method and a computerized system for implementing any type of repetitive business transaction, whereby on the basis of previous experience with similar transactions (a-posteriori information) some expendable resources is to be allocated for each particular transaction thus affecting its effectiveness.

What is claimed is:

1. A computer-based method for optimal allocation of expendable resources in Internet marketing with resource-dependant effectiveness and use of a-posteriori information, comprising the steps of:
a) creating a list of Internet Marketing (IM) providers to be considered, contacting them over the Internet, and collecting from them a-priori data about elementary marketing operations (EMO) available and resource-dependant effectiveness of these EMO;
b) choosing the optimal resource allocation decision rule (DR) for EMO to be implemented and defining optimal resource-dependant effectiveness parameters for the first EMO;
c) implementing the first EMO, evaluating its results through direct or indirect (using IM provider as intermediary) Internet contact with marketing addressees who responded for the first EMO, thereby collecting a-posteriori data on EMO effectiveness;
d) checking the current status of resources available and proceeding according to recommendations of optimal DR chosen in step b) to the next EMO if resources are available, or ending the current IM operation otherwise;
e) defining optimal resource-dependant effectiveness parameters for the next EMO, implementing the next EMO, and evaluating its results through direct or indirect (using IM provider as intermediary) Internet contact with marketing addressees who responded for that EMO thus collecting a-posteriori data on EMO effectiveness; and
f) iteratively performing steps d) and e) till all available resources are allocated.

2. The computer-based method of claim 1, wherein said step of choosing the optimal resource allocation DR D*(A) for EMO to be implemented further comprises the evaluation of the influence for a-posteriori evaluated parameters B in average in accordance with the formula:
$$W [ {D}^{*} ( A ) ] = {max}_{D ∈ \hat{D}} {\int }_{B ∈ \hat{B}} W [ D ( A , B ) ] ⅆ F ( B ) , \qquad ( 2 )$$
where
vector-function D(A,B) describes optimal strategies of the operational party on the basis of usage of both a-priori (A) and a-posteriori (B) known information;
W [D (A, B)]—is an optimality criterion W, to attain the maximal value W* of which constitutes the goal of the operational party in the marketing operation, \hat{D} is a functional space of the admissible DR D,
an a-priori law of distribution F (B) for a-posteriori evaluated parameters B presumed known,
\hat{B} is set of possible values for a-posteriori evaluated parameters B.

3. The computer-based method of claim 1, wherein said step of choosing the optimal resource allocation decision rule D*(A) for EMO to be implemented further comprises the evaluation of the influence for a-posteriori evaluated parameters B in a form of considering a most probable value of B, or the value \tilde{B}, which is equal to a mode of the distribution F (B) in accordance with the formula:
$$W [ {D}^{*} ( A ) ] = {max}_{D ∈ \hat{D}} W [ D ( A , \tilde{B} ) ] . \qquad ( 3 )$$

4. The computer-based method of claim 1, wherein said step of choosing the optimal resource allocation decision rule D (A, B) for EMO to be implemented further comprises the evaluation of the influence for a-posteriori evaluated parameters B in a form of a guaranteed result principle (Minimax Criterion) in accordance with the formula:
$$W [ {D}^{*} ( A ) ] = {min}_{B ∈ \hat{B}} W [ {D}^{*} ( A , B ) ] = {max}_{D ∈ \hat{D}} {min}_{B ∈ \hat{B}} W [ D ( A , B ) . \qquad ( 5 )$$

5. The computer-based method of claim 1, wherein said step of choosing the optimal resource allocation decision rule D*(A) for EMO to be implemented further comprises the evaluation of the influence for a-posteriori evaluated parameters B in a form of optimal “physical mix” D (A) in accordance with the formulae:
$${\overline{D}}^{*} ( A ) = {\int }_{B ∈ \hat{B}} {D}^{*} ( A , B ) ⅆ F ( B ) , W [ {D}^{*} ( A ) ] = W [ {\overline{D}}^{*} ( A ) ] . \qquad ( 4 )$$

6. The computer-based method of claim 2, wherein said step of defining optimal resource-dependant effectiveness parameters is considering as such the number of expendable resources units n*ₛ used in EMO number “s” and defined by the formula
$${n}_{s}^{*} = const = \frac{{n}_{\sum }}{\overline{k}} , ∀ s ∈ \overline{1 , \overline{k}} , \qquad ( 24 )$$
where
$$\overline{k} = {\int }_{0}^{∞} s ⅆ F ( s ) ,$$
F(s) is an a-priori law of distribution for parameter “s”,
under the restraint on expendable resources n_{Σ} available
$${\sum }_{i = 1}^{\overline{k}} {n}_{i} = {n}_{\sum } . \qquad ( 17 )$$

7. The computer-based method of claim 2, wherein said step of defining optimal resource-dependant effectiveness parameters is considering as such the number of expendable resources units n*ₛ used in EMO number “s” and defined by the formula
$${n}_{s}^{*} = \frac{{n}_{\sum }}{{\overline{k}}_{s}} , \qquad ( 26 )$$
where
$$\begin{matrix}{\overline{k}}_{s} = {\sum }_{k = s}^{∞} kP ( {H}_{k} / {A}_{s} ) , & ( 25 ) \\ P ( {H}_{k} / {A}_{s} ) = \{ \begin{matrix}\frac{P ( {H}_{k} )}{{\sum }_{i = s}^{∞} P ( {h}_{i} )} , k ∈ \overline{s , ∞} \\ 0 , k ∈ \overline{0 , s - 1}\end{matrix} & ( 23 )\end{matrix}$$
P(Hₖ) is a prior probability of the hypothesis Hₖ (an exact number of EMO to happen is k),
P(Hₖ/Aₛ) is a posterior conditional probability of the hypothesis Hₖ under condition of Aₛ (“s” EMO had happened already).

8. The computer-based method of claim 2, wherein said step of defining optimal resource-dependant effectiveness parameters is considering as such the number of expendable resource units n*ₛ used in EMO number “s” and defined by the formula
$${n}_{s}^{*} = \frac{{n}_{\sum } - {\sum }_{i = 1}^{s - 1} {n}_{i}^{*}}{{\overline{k}}_{s} - s + 1} = {n}_{\sum } \frac{1 - {\sum }_{i = 1}^{s - 1} \frac{1}{{\overline{k}}_{i}}}{{\overline{k}}_{s} - s + 1} . \qquad ( 27 )$$

9. The computer-based method of claim 3, wherein said step of defining optimal resource-dependant effectiveness parameters is considering as such the number of expendable resource units nS used in EMO number “s” and defined by the formula
$${n}_{s}^{*} = const = \frac{{n}_{\sum }}{\tilde{k}} , ∀ s ∈ \overline{1 , \tilde{k}} , \qquad ( 24 a )$$
where
$$\tilde{k} = index {max}_{j ∈ \overline{1 , ∞}} P ( {A}_{j} ) ,$$
P (Aₛ) is a prior probability for an exact number “s” of EMO to happen.

10. The computer-based method of claim 3, wherein said step of defining optimal resource-dependant effectiveness parameters is considering as such the number of expendable resource units n*ₛ used in EMO number “s” and defined by the formula
$${n}_{s}^{*} = \frac{{n}_{\sum }}{{\tilde{k}}_{s}} , \\ where {\tilde{k}}_{s} = index {max}_{j ∈ \overline{s , ∞}} P ( {H}_{J} / {A}_{S} ) . \qquad ( 26 a )$$

11. The computer-based method of claim 3, wherein said step of defining optimal resource-dependant effectiveness parameters is considering as such the number of expendable resource units n*ₛ used in EMO number “s” and defined by the formula
$${n}_{s}^{*} = \frac{{n}_{\sum } - {\sum }_{i = 1}^{s - 1} {n}_{i}^{*}}{{\tilde{k}}_{s} - s + 1} = {n}_{\sum } \frac{1 - {\sum }_{i = 1}^{s - 1} \frac{1}{{\tilde{k}}_{i}}}{{\tilde{k}}_{s} - s + 1} . \qquad ( 27 a )$$

12. The computer-based method of claim 4, wherein said step of defining optimal resource-dependant effectiveness parameters is considering as such the number of expendable resource units n*ₛ used in EMO number “s” and defined by the formula
$${n}_{s}^{*} = const = \frac{{n}_{\sum }}{{k}^{Γ}} , ∀ s ∈ \overline{1 , {k}^{Γ}} , \qquad ( 32 )$$
F(k)=α, (31)
where α is a confidence level for guaranteed result (may be considered 0.90; 0.95; 0.99; etc),
k—a number of EMO that will happen with a confidence level equal to α.

13. The computer-based method of claim 4, wherein said step of defining optimal resource-dependant effectiveness parameters is considering as such the number of expendable resources units n*ₛ used in EMO number “s” and defined by the formula
$${n}_{s}^{*} = \frac{{n}_{\sum }}{{k}_{s}^{Γ}} , \qquad ( 34 )$$
where k_{S} should be found from a relation
$${\sum }_{k = s}^{{k}_{s}^{Γ}} P ( {H}_{k} / {A}_{S} ) = {α}_{Γ} . \qquad ( 33 )$$

14. The computer-based method of claim 4, wherein said step of defining optimal resource-dependant effectiveness parameters is considering as such the number of expendable resources units n*ₛ used in EMO number “s” and defined by the formula
$${n}_{s}^{*} = \frac{{n}_{\sum } - {\sum }_{i = 1}^{s - 1} {n}_{i}^{*}}{{k}_{s}^{Γ} - s + 1} = {n}_{\sum } \frac{1 - {\sum }_{i = 1}^{s - 1} \frac{1}{{k}_{i}^{Γ}}}{{k}_{s}^{Γ} - s + 1} . \qquad ( 35 )$$

15. The computer-based method of claim 5, wherein said step of defining optimal resource-dependant effectiveness parameters is considering as such the number of expendable resources units n*ₛ used in EMO number “s” and defined by the formula
$${n}_{S}^{*} = const = {n}_{\sum } {\sum }_{k = 1}^{∞} \frac{1}{k} P ( {H}_{k} ) . \qquad ( 36 )$$

16. The computer-based method of claim 5, wherein said step of defining optimal resource-dependant effectiveness parameters is considering as such the number of expendable resources units n*ₛ used in EMO number “s” and defined by the formula
$${n}_{S}^{*} = {n}_{\sum } {\sum }_{k = s}^{∞} \frac{1}{k} P ( {H}_{k} / As ) . \qquad ( 37 )$$

17. The computer-based method of claim 5, wherein said step of defining optimal resource-dependant effectiveness parameters is considering as such the number of expendable resources units n*ₛ used in EMO number “s” and defined by the formula
$${n}_{S}^{*} = ( {n}_{\sum } - {\sum }_{i = 1}^{s - 1} {n}_{i}^{*} ) {\sum }_{k = s}^{∞} \frac{1}{k} P ( {H}_{k} / {A}_{S} ) = {n}_{\sum } [ 1 - {\sum }_{i - 1}^{s - 1} {\sum }_{k = 1}^{∞} \frac{1}{k} P ( {H}_{k} / {A}_{i} ) ] {\sum }_{k = s}^{∞} \frac{1}{k} P ( {H}_{k} / {A}_{S} ) . \qquad ( 38 )$$

18. computer-based decision support system for optimal allocation of expendable resources in internet marketing with resource-dependant effectiveness and use of a-posteriori information, said system comprising:
a plurality of marketing addressees' computer terminals with their communication means;
a plurality of IM providers' computer terminals hosted over the Internet with their communication means, said computer terminals comprising:
i) an a-priori databank comprising data about EMO available and resource-dependant effectiveness of these EMO;
ii) sensors of a-posteriori data being adapted to acquire the results of EMO;
iii) an a-posteriori data bank connected with said sensors and having possibility to register the results of EMO;
a central operating block with its communication means, said central operating block comprising:
i) an IM providers' databank, that is adapted for having possibilities through said communication means of said central operating block to contact interactively said IM providers' computer terminals, and is programmed for creating the list of IM providers to be considered;
ii) an a-priori databank, that is coupled to said IM providers databank, and is adapted for having possibilities through said communication means of said central operating block to contact interactively said a-priori databanks of IM providers hosted over the Internet, and is programmed for searching said databanks and collecting from them the a-priori data about elementary marketing operations (EMO) available and resource-dependant effectiveness of these EMO;
iii) an a-posteriori databank, that is coupled to said a-priori databank, and is adapted for having possibilities through said communication means of said central operating block to contact interactively said a-posteriori databanks of IM providers hosted over the Internet or directly said marketing addressees' computer terminals, and is programmed for searching said a-posteriori databanks and collecting from them the available a-posteriori data about EMO results;
iv) a DR optimization unit, that is coupled with said a-priori and a-posteriori databanks, and is programmed for choosing the optimal resource allocation DR for EMO to be implemented;
v) a resource counter, that is coupled with said a-posteriori databank, and is programmed for registering expended resources; and
vi) a resource allocation unit, that is coupled with said a-priori and a-posteriori databanks, DR optimization unit, and resource counter, and is programmed for checking the current status of resources available and defining optimal resource-dependant effectiveness parameters for the next EMO accordingly to recommendations of optimal DR chosen by the said DR optimization unit if resources are available, or ending the current IM operation otherwise.

19. The system according to claim 18, wherein said DR optimization unit is programmed for choosing the optimal resource allocation decision rule D*(A) for EMO to be implemented by evaluating the influence of a-posteriori parameters B in average in accordance with the formula:
$$W [ {D}^{*} ( A ) ] = {max}_{D ∈ \hat{D}} {\int }_{B ∈ \hat{B}} W [ D ( A , B ) ] ⅆ F ( B ) , \qquad ( 2 )$$
where
vector-function D(A,B) describes optimal strategies of the operational party on the basis of usage of both a-priori (A) and a-posteriori (B) known information,
W [D(A, B)]—is an optimality criterion W, to attain the maximal value W* of which constitutes the goal of the operational party in the marketing operation,
\hat{D}—the functional space of the admissible DR D,
an a-priori law of distribution F (B) for a-posteriori evaluated parameters B presumed known,
\tilde{B}—the set of possible values for a-posteriori evaluated parameters B.

20. The system according to claim 18, wherein said DR optimization unit is programmed for choosing the optimal resource allocation decision rule D*(A) for EMO to be implemented by evaluating the influence of a-posteriori parameters B in a form of considering a most probable value of B, or the value B, which is equal to a mode of the distribution F (B) in accordance with the formula:
$$W [ {D}^{*} ( A ) ] = {max}_{D ∈ \hat{D}} W [ D ( A , \tilde{B} ) ] . \qquad ( 3 )$$

21. The system according to claim 18, wherein said DR optimization unit is programmed for choosing the optimal resource allocation decision rule D*(A) for EMO to be implemented by evaluating the influence of a-posteriori parameters B in a form of a guaranteed result principle (Minimax Criterion) in accordance with the formula:
$$W [ {D}^{*} ( A ) ] = {min}_{B ∈ \hat{B}} W [ {D}^{*} ( A , B ) ] = {max}_{D ∈ \hat{D}} {min}_{B ∈ \hat{B}} W [ D ( A , B ) ] . \qquad ( 5 )$$

22. The system according to claim 18, wherein said DR optimization unit is programmed fore choosing the optimal resource allocation decision rule D*(A) for EMO to be implemented by evaluating the influence of a-posteriori parameters B in a form of a in a form of optimal “physical mix” \overline{D}*(A) in accordance with the formulae:
$${\overline{D}}^{*} ( A ) = {\int }_{B ∈ \hat{B}} {D}^{*} ( A , B ) ⅆ F ( B ) , W [ {D}^{*} ( A ) ] = W [ {\overline{D}}^{*} ( A ) ] . \qquad ( 4 )$$

23. The system according to claim 19, wherein said resource allocation unit is programmed for defining the number of expendable resources units n*ₛ used in EMO number “s” by the formula:
$${n}_{s}^{*} = const = \frac{{n}_{\sum }}{\overline{k}} , ∀ s ∈ \overline{1 , \overline{k}} , \qquad ( 24 )$$
where
$$\overline{k} = {\int }_{0}^{∞} s ⅆ F ( s ) ,$$
F(s) is an a-priori law of distribution for parameter “s”,
under the restraint on expendable resources n_{Σ} available
$${\sum }_{i = 1}^{\overline{k}} {n}_{i} = {n}_{\sum } . \qquad ( 17 )$$

24. The system according to claim 19, wherein said resource allocation unit is programmed for defining the number of expendable resources units n*ₛ used in EMO number “s” by the formula:
$${n}_{s}^{*} = \frac{{n}_{\sum }}{{\overline{k}}_{s}} , \qquad ( 26 )$$
where
$$\begin{matrix}{\overline{k}}_{s} = {\sum }_{k = s}^{∞} kP ( {H}_{k} / {A}_{s} ) , & ( 25 ) \\ P ( {H}_{k} / {A}_{s} ) = \{ \begin{matrix}\frac{P ( {H}_{k} )}{{\sum }_{i = s}^{∞} P ( {h}_{i} )} , k ∈ \overline{s , ∞} \\ 0 , k ∈ \overline{0 , s - 1} ,\end{matrix} & ( 23 )\end{matrix}$$
P(Hₖ)—a prior probability of the hypothesis Hₖ (an exact number of EMO to happen is k),
P(Hₖ/Aₛ)—a posterior conditional probability of the hypothesis Hₖ under condition of As (“s” EMO had happened already).

25. The system according to claim 19, wherein said resource allocation unit is programmed for defining the number of expendable resources units n*ₛ used in EMO number “s” by the formula:
$${n}_{s}^{*} = \frac{{n}_{\sum } - {\sum }_{i = 1}^{s - 1} {n}_{i}^{*}}{{\overline{k}}_{s} - s + 1} = {n}_{\sum } \frac{1 - {\sum }_{i = 1}^{s - 1} \frac{1}{{\overline{k}}_{i}}}{{\overline{k}}_{s} - s + 1} . \qquad ( 27 )$$

26. The system according to claim 20, wherein said resource allocation unit is programmed for defining the number of expendable resources units n*ₛ used in EMO number “s” by the formula:
$${n}_{s}^{*} = const = \frac{{n}_{\sum }}{\tilde{k}} , ∀ s ∈ \overline{1 , \tilde{k}} , \qquad ( 24 a )$$
where
$$\tilde{k} = index { m \underline{ax}}_{j ∈ l , ∞} P ( {A}_{j} ) ,$$
P (Aₛ) is a prior probability for an exact number “s” of EMO to happen.

27. The system according to claim 20, wherein said resource allocation unit is programmed for defining the number of expendable resources units n*ₛ used in EMO number “s” by the formula:
$${n}_{s}^{*} = \frac{{n}_{\sum }}{{\tilde{k}}_{s}} , \\ where {\tilde{k}}_{s} = index {max}_{j ∈ \overline{s , ∞}} P ( {H}_{J} / {A}_{S} ) . \qquad ( 26 a )$$

28. The system according to claim 20, wherein said resource allocation unit is programmed for defining the number of expendable resources units n*ₛ used in EMO number “s” by the formula:
$${n}_{s}^{*} = \frac{{n}_{\sum } - {\sum }_{i = 1}^{s - 1} {n}_{i}^{*}}{{\tilde{k}}_{s} - s + 1} = {n}_{\sum } \frac{1 - {\sum }_{i = 1}^{s - 1} \frac{1}{{\tilde{k}}_{i}}}{{\tilde{k}}_{s} - s + 1} \qquad ( 27 a )$$

29. The system according to claim 21, wherein said resource allocation unit is programmed for defining the number of expendable resources units n*ₛ used in EMO number “s” by the formulae:
$${n}_{s}^{*} = const = \frac{{n}_{\sum }}{{k}^{Γ}} , ∀ s ∈ \overline{1 , {k}^{Γ}} , \qquad ( 32 )$$
F(k)=α, (31)
where α—a confidence level for guaranteed result (may be considered 0.90; 0.95; 0.99; etc),
k—a number of EMO that will happen with a confidence level equal to α.

30. The system according to claim 21, wherein said resource allocation unit is programmed for defining the number of expendable resources units n*ₛ used in EMO number “s” by the formula:
$${n}_{s}^{*} = \frac{{n}_{\sum }}{{k}_{s}^{Γ}} , \qquad ( 34 )$$
where k_{S} should be found from a relation
$${\sum }_{k = s}^{{k}_{s}^{Γ}} P ( {H}_{k} / {A}_{S} ) = {α}_{Γ} \qquad ( 33 )$$

31. The system according to claim 21, wherein said resource allocation unit is programmed for defining the number of expendable resources units n*ₛ used in EMO number “s” by the formula:
$${n}_{s}^{*} = \frac{{n}_{Σ} - {\sum }_{i = 1}^{s - 1} {n}_{i}^{*}}{{k}_{s}^{Γ} - s + 1} = {n}_{Σ} \frac{1 - {\sum }_{i = 1}^{s - 1} \frac{1}{{k}_{i}^{Γ}}}{{k}_{s}^{Γ} - s + 1} . \qquad ( 35 )$$

32. The system according to claim 22, wherein said resource allocation unit is programmed for defining the number of expendable resources units n*ₛ used in EMO number “s” by the formula:
$${n}_{S}^{*} = const = {n}_{Σ} {\sum }_{k = 1}^{∞} \frac{1}{k} P ( {H}_{k} ) . \qquad ( 36 )$$

33. The system according to claim 22, wherein said resource allocation unit is programmed for defining the number of expendable resources units n*ₛ used in EMO number “s” by the formula:
$${n}_{S}^{*} = {n}_{Σ} {\sum }_{k = s}^{∞} \frac{1}{k} P ( {H}_{k} / As ) . \qquad ( 37 )$$

34. The system according to claim 22, wherein said resource allocation unit is programmed for defining the number of expendable resources units n*ₛ used in EMO number “s” by the formula:
$$\begin{matrix}{n}_{S}^{*} = ( {n}_{Σ} - {\sum }_{i = 1}^{s - 1} {n}_{i}^{*} ) {\sum }_{k = s}^{∞} \frac{1}{k} P ( {H}_{k} / {A}_{S} ) \\ = {n}_{Σ} [ 1 - {\sum }_{i - 1}^{s - 1} {\sum }_{k = 1}^{∞} \frac{1}{k} P ( {H}_{k} / {A}_{i} ) ] {\sum }_{k = s}^{∞} \frac{1}{k} P ( {H}_{k} / {A}_{S} ) .\end{matrix} \qquad ( 38 )$$
